(19) United States
(12) Patent Application Publication
(10) Pub. No.: US 2021/0268808 A1
(43) Pub. Date: Sep. 2, 2021

(54) LASER RECORDING METHOD AND LASER RECORDING DEVICE

(71) Applicants: Tomohiro YAMASHITA, Tokyo (JP); Tomomi ISHIMI, Tokyo (JP); Kazutaka YAMAMOTO, Tokyo (JP); Yuki OGAWA, Tokyo (JP); Yohsuke TANAKA, Tokyo (JP)

(72) Inventors: Tomohiro YAMASHITA, Shizuoka (JP); Tomomi ISHIMI, Shizuoka (JP); Kazutaka YAMAMOTO, Kanagawa (JP); Yuki OGAWA, Shizuoka (JP); Yohsuke TANAKA, Shizuoka (JP)

(21) Appl. No.: 17/258,664

(22) PCT Filed: Jul. 1, 2019
(86) PCT No.: PCT/JP2019/026195

§ 371 Date: Jan. 7, 2021

(30) Foreign Application Priority Data
Jul. 10, 2018 (JP) 2018-130427

(51) Int. Cl. B41J 2/455; B41J 2/475; B41M 5/26

(52) U.S. Cl. CPC B41J 2/455; B41M 5/26; B41J 2/475

(57) ABSTRACT

A laser recording method is for processing a recording object with laser light emitted from a laser light source. The laser recording method includes: detecting a moving speed of the recording object with a location of the laser light source when the laser light source emits laser light, as an observation point, while moving at least one of the recording object and the laser light source; and correcting power output of the laser light set such that an amount of energy applied by the laser light per unit area of the recording object is constant even if the moving speed is changed, to compensate energy loss derived from thermal diffusion occurring on the recording object based on the moving speed detected at the detecting.

### TECHNICAL FIELD

The present invention relates to a laser recording method and a laser recording device.

### BACKGROUND ART

Such a conventional laser processing apparatus is known that irradiates a workpiece with laser light to process the piece. This type of known laser processing apparatus includes a laser irradiation device such as a laser array. The laser array has a plurality of arrayed semiconductor lasers as laser light-emitting devices that emit laser beams toward respective different positions in a certain direction. Laser recording apparatuses are also known that use such a laser processing apparatus to write and record images and others to a thermosensitive recording medium as a recording object.

Patent Literature 1 describes a method of laser processing to cut a long optical film as a workpiece into pieces having a certain width. The method controls laser power output and maintains the amount of energy per unit area of the laser light applied to the optical film constant when the processing rate of the laser light to the optical film is changed with a change in the moving speed of the optical film.

### SUMMARY OF INVENTION

### Technical Problem

In this process, all the power output of laser light, emitted from a laser light source onto the thermosensitive recording medium as a recording object, is not always used as energy for recording such as writing. More specifically, the laser power output applied to the thermosensitive recording medium through irradiation is partially dissipated to the periphery of the area irradiated with the laser, which phenomenon is called heat diffusion, and the part of the power output is therefore not used as energy for recording such as writing. Then, there is a problem that when performing the recording processing to write an image or the like with laser light while moving at least the thermosensitive recording medium as a recording object or the laser light source, the quality of recording processing including writing to the thermosensitive recording medium is difficult to be maintained due to the effect of the above heat diffusion, even if the amount of energy per unit area applied to the thermosensitive recording medium is made constant according to the relative speed between the thermosensitive recording medium and the laser light source.

From the above viewpoint, it is an object of the present invention to maintain the quality of recording processing including, for example, writing to a recording object.

### Solution to Problem

According to an aspect of the present invention, a laser recording method is for processing a recording object with laser light emitted from a laser light source. The laser recording method includes: detecting a moving speed of the recording object with a location of the laser light source when the laser light source emits laser light, as an observation point, while moving at least one of the recording object and the laser light source; and correcting power output of the laser light set such that an amount of energy applied by the laser light per unit area of the recording object is constant even if the moving speed is changed, to compensate energy loss derived from thermal diffusion occurring on the recording object based on the moving speed detected at the detecting.

### Advantageous Effects of Invention

An embodiment of the present invention provides the advantageous effect that the quality of recording processing including, for example, writing to a recording object can be maintained.

### BRIEF DESCRIPTION OF DRAWINGS

FIG. 1 is a schematic perspective view of an image recording system according to a first embodiment.

FIG. 2 is a schematic perspective view of a configuration of the image recording system.

FIG. 3 is a view illustrating the geometry of a laser array.

FIG. 4A is a diagram for explaining the relation between a control pulse and a light pulse.

FIG. 4B is a diagram for explaining the relation between the control pulse and the light pulse.

FIG. 5 is a diagram for explaining printing to a thermosensitive recording label in the rest state.

FIG. 6 is a diagram for explaining printing to a moving thermosensitive recording label.

FIG. 7 is a block diagram that illustrates a part of an electrical circuit of the image recording system.

FIG. 8A is a diagram for explaining an energy control scheme in laser printing.

FIG. 8B is a diagram for explaining the energy control scheme in laser printing.

FIG. 8C is a diagram for explaining the energy control scheme in laser printing.

FIG. 9 is a graph that illustrates the relation between laser power output to a thermosensitive recording label and the moving speed.

FIG. 10 is a graph that illustrates the relation between a pulse width to a thermosensitive recording label and the moving speed.

FIG. 11 is a graph that illustrates the relation between the color optical density value and the moving speed of a thermosensitive recording label.

FIG. 12A is a diagram for explaining results of printing with no correction provided.

FIG. 12B is a diagram for explaining results of printing with no correction provided.

FIG. 12C is a diagram for explaining results of printing with no correction provided.

FIG. 13A is a diagram for explaining an example of energy correction processing according to the first embodiment.

FIG. 13B is a diagram for explaining the example of energy correction processing according to the first embodiment.

FIG. 13C is a diagram for explaining the example of energy correction processing according to the first embodiment.

FIG. 13D is a diagram for explaining the example of energy correction processing according to the first embodiment.

FIG. 14 is a flowchart that schematically illustrates a flow of printing processing of a controller.

FIG. 15A is a diagram for explaining an example of energy correction processing according to a second embodiment.

FIG. 15B is a diagram for explaining the example of energy correction processing according to a second embodiment.

FIG. 15C is a diagram for explaining the example of energy correction processing according to a second embodiment.

FIG. 15D is a diagram for explaining the example of energy correction processing according to a second embodiment.

### DESCRIPTION OF EMBODIMENTS

Exemplary embodiments of a laser recording method and a laser recording device are described in detail below with reference to the accompanying drawings. A laser recording device irradiates a thermosensitive recording medium as a recording object with laser beams to provide laser processing and to record an image and others on the medium by writing.

The above image includes any visible information, and is selectable as appropriate depending on the purpose. Examples of the image include letters, signs, lines, figures, solid images, a combination thereof, and a two-dimensional code such as a barcode and a QR code (registered trademark).

The above recording object is not limited to a specific object and may be any object on which information can be recorded with a laser, and is selectable as appropriate depending on the purpose. The recording object includes any object capable of absorbing light and converting the light into heat to form an image. Engraving a metal is one of the examples. Examples of the recording object include a thermosensitive recording medium and a structure having a thermosensitive recording part.

The thermosensitive recording medium is composed of a supporting body, an image recording layer on the supporting body, and other layers as necessary. Such layers may be configured as a single layer or as a multilayer structure, and may be mounted on the other surface of the supporting body.

Image Recording Layer

The image recording layer contains a leuco dye and a color developer and other components as necessary.

A leuco dye is not specifically limited and selectable as appropriate depending on the purpose from dyes usually used for a thermosensitive recording material. The leuco dye preferably uses a leuco compound for dye selected from, for example, the triphenylmethane series, the fluoran series, the phenothiazine series, the auramine series, the spiropyran series, and the indolinophtalide series.

The color developer is selected from various electron-accepting compounds or oxidants that develop color of a leuco dye upon contact.

Examples of other components include binder resin, a photo-thermal conversion material, a heat soluble material, an antioxidant, a light stabilizer, a surfactant, a glidant, and a filler.

Supporting Body

The supporting body is not specifically limited in shape, structure, size, and the like, and is selectable as appropriate depending on the purpose. For example, the supporting body may have a flat-plate shape. The supporting body may be configured as a single layer structure or a multilayer structure. The size of the supporting body is selectable as appropriate depending on the size or the like of the thermosensitive recording medium.

Other Layers

Examples of other layers include a photo-thermal conversion layer, a protective layer, an under layer, an ultraviolet absorbing layer, an oxygen blocking layer, an intermediate layer, a back layer, an adhesive layer, and a glue layer.

The thermosensitive recording medium can be formed into a desired shape depending on the usage. The thermosensitive recording medium may be formed into, for example, cards, tags, labels, sheets, and rolls. Examples of the card include a prepaid card, a point card, and a credit card. The recording medium formed into a tag smaller than cards is usable as a price tag, for example. The recording medium formed into a tag larger than cards is usable as, for example, a process control chart, a shipping instruction, and a ticket. Since a recording medium formed into a label is adhesive and can be formed into various sizes, the medium is usable for process management, product management, and the like by being attached to a repeatedly used cart, a case, a box, a container, or the like. Moreover, since a recording medium formed into a sheet larger than cards has a wider space for recording images, the medium is usable for general documents, instructions for process management, and other purposes.

Examples of the thermosensitive recording part of the structure include a portion, of a surface of the structure, where a label-type thermosensitive recording medium is attached and a portion, of a surface of the structure, where a thermosensitive recording material is applied. The structure having a thermosensitive recording part is not specifically limited as long as it has such a thermosensitive recording part formed on its surface, and is selectable as appropriate depending on the purpose. Examples of the structure having the thermosensitive recording part include various products such as a plastic bag, a PET bottle, and a can, a container for transfer such as a cardboard and a cart, a partially finished product, and an industrial product.

An example structure having a thermosensitive recording part as a recording object will be described. Specifically, a laser recording device to record images on a long thermosensitive recording label, as a recording object, will now be described.

### First Embodiment

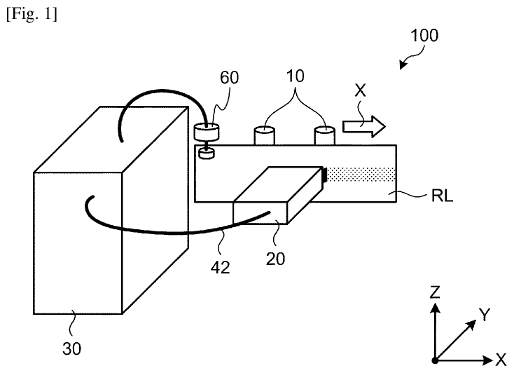

FIG. 1 is a schematic perspective view of an image recording system 100 as a laser recording device according to a first embodiment. In the following description, the direction of conveyance (move) of a thermosensitive recording label RL will be indicated as the X-axis direction, the vertical direction will be indicated as the Z-axis direction, and a direction intersecting with both the direction of travel and the vertical direction will be indicated as the Y-axis direction.

As described below, the image recording system 100 irradiates the thermosensitive recording label RL as a recording object with laser beams to process the surface and to record images on the object.

As illustrated in FIG. 1, the image recording system 100 includes conveying devices 10, a recording unit 20, a body 30, an optical fiber 42, and an encoder 60.

The recording unit 20 processes the surface of a recording object and records visual images on the recording object by irradiating the object with laser beams. The recording unit 20 corresponds to a laser irradiation device. The recording unit 20 is disposed on the side of −Y with respect to the conveying device 10, in other words, on the side of −Y to the conveyor path.

The conveying device 10 conveys the thermosensitive recording label RL using, for example, a plurality of revolution rollers.

The body 30 is connected with the conveying devices 10, the recording unit 20, and others, and integrally controls the image recording system 100.

The encoder 60 acquires the moving speed of the thermosensitive recording label RL.

The thermosensitive recording label RL will now be described. The thermosensitive recording label RL develops color by thermal energy applied by the laser.

The thermosensitive recording label RL as a thermosensitive recording medium records images with its color tone changed by heat. The thermosensitive recording medium, as the thermosensitive recording label RL, in this embodiment is a single-time image recording medium. The thermosensitive recording medium can be replaced by a thermoreversible recording medium capable of repeatedly recording images.

The thermosensitive recording medium used as the thermosensitive recording label RL of this embodiment is made of a material (photo-thermal conversion material) to absorb laser light and convert the light into heat and a material having the hue, the reflectance, or the like changing by heat.

The photo-thermal conversion material is broadly classed into inorganic materials and organic materials. Examples of the inorganic material include particles of at least one of carbon black, metal borides and metal oxides such as Ge, Bi, In, Te, Se and Cr. Of the above inorganic materials, metal borides and metal oxides are more preferable because they absorb a larger amount of light in the range of the near infrared wavelengths and absorb a smaller amount of light in the range of visible light wavelengths. The inorganic material preferably includes at least one type selected from, for example, hexaboride, a tungsten oxide compound, antimony tin oxide (ATO), indium tin oxide (ITO), and zinc antimonate.

Examples of hexaboride include LaB6, CeB6, PrB6, NdB6, GdB6, TbB6, DyB6, HoB6, YB6, SmB6, EuB6, ErB6, TmB6, YbB6, LuB6, SrB6, CaB6, and (La, Ce)B6.

Examples of a tungsten oxide compound include fine particles of tungsten oxide represented by the general formula: WyOz, (where W is tungsten, O is oxygen, 2.2≤z/y≤2.999) and fine particles of a complex tungsten oxide compound represented by the general formula: MxWyOz, (where M is one or more elements selected from H, He, alkali metals, alkaline earth metals, rare-earth elements, Mg, Zr, Cr, Mn, Fe, Ru, Co, Rh, Ir, Ni, Pd, Pt, Cu, Ag, Au, Zn, Cd, Al, Ga, In, Tl, Si, Ge, Sn, Pb, Sb, B, F, P, S, Se, Br, Te, Ti, Nb, V, Mo, Ta, Re, Be, Hf, Os, Bi, and I, W is tungsten, O is oxygen, 0.001≤x/y≤1, 2.2≤z/y≤3.0) as described in Literature of International Publication No. 2005/037932 and Japanese Unexamined Patent Publication No. 2005-187323.

Of the above tungsten oxide compounds, cesium-doped tungsten oxide is more preferable in the point that the compound absorbs a larger amount of light in the range of the near infrared and absorbs a smaller amount of light in the range of visible light.

Furthermore, as a tungsten oxide compound, of antimony tin oxide (ATO), indium tin oxide (ITO), and zinc antimonate, ITO is more preferable in the point that the compound absorbs a larger amount of light in the range of near infrared wavelengths and absorbs a smaller amount of light in the range of visible light wavelengths. These compounds are layered by using vacuum vapor deposition or by bonding particulate materials to one another with resin or the like.

The organic materials can use various types of dye as appropriate depending on the spectrum wavelength to be absorbed. When a semiconductor laser is used for a light source, such a near-infrared absorbing dye is used that has an absorption peak approximately from 600 nm to 1,200 nm. Examples of the organic material include cyanine dyes, quinone dyes, quinoline derivatives of indonaphthol, phenylenediamine nickel complexes, and phthalocyanine dyes.

The photo-thermal conversion material may use a single material or may use a combination of materials. The photo-thermal conversion material may be included in the image recording layer or in any site other than the image recording layer. When the photo-thermal conversion material is used in a site other than the image recording layer, a photo-thermal conversion layer is preferably disposed next to a thermoreversible recording medium. The photo-thermal conversion layer is made of at least a photo-thermal conversion material and binder resin.

As a material having the hue, the reflectance, or the like changing by heat, a known material may be used such as a combination of an electron-donating dye precursor and an electron-accepting color developer, used for conventional thermosensitive paper. Examples of a material having the hue, the reflectance, or the like changing by heat further include such a material that is subjected to a complex reaction of heat and light, for example, a reaction of color change associated with solid phase polymerization, caused by a diacetylene compound heated and irradiated with ultraviolet light.

FIG. 2 is a schematic perspective view of a configuration of the image recording system 100.

The image recording system 100 includes a laser processing device 40 serving as a laser light source. The laser processing device 40 includes a laser irradiation device 14 including a laser array unit 14a and a fiber array unit 14b, and an optical unit 43. In this embodiment, the laser irradiation device 14 uses a fiber array recording device. The fiber array recording device provides surface processing and records images using a fiber array where a plurality of laser discharge portions of optical fibers are arrayed along a main scanning direction (the Z-axis direction) intersecting with a sub-scanning direction (the X-axis direction), which is a moving direction of the thermosensitive recording label RL as a recording object. The laser processing device 40 irradiates the thermosensitive recording label RL with laser beams emitted from laser light-emitting devices 41 through fiber arrays and records an image (visible image) depicted based on a drawing unit.

The laser array unit 14a includes a plurality of arrayed laser light-emitting devices 41, a cooling unit 50 to cool the laser light-emitting devices 41, a plurality of actuation drivers 45 for respective laser light-emitting devices 41 to actuate the corresponding laser light-emitting devices 41, and a controller 46 to control the actuation drivers 45. The controller 46 is connected with a power source 48 to supply power to the laser light-emitting devices 41 and an image information output unit 47 such as a personal computer to output image information.

The laser light-emitting device 41 is selectable as appropriate depending on the purpose, and may be selected from, for example, a semiconductor laser, a solid-state laser, and a dye laser. Of these lasers, a semiconductor laser is more preferable for the laser light-emitting device 41 in that the semiconductor laser enables selection from a wide range of wavelengths and is small enough to allow a reduction in size and cost of the device.

The wavelength of laser light emitted from the laser light-emitting device 41 is not specifically limited and selectable as appropriate depending on the purpose. In particular, the wavelength in the range of 700 nm to 2000 nm is preferable, and the range of 780 nm to 1600 nm is more preferable.

Not all the energy applied to the laser light-emitting device 41, serving as light-emitting means, is converted into laser light. A part of the energy, which is not converted into laser light, is converted into heat, and the laser light-emitting device 41 therefore produces heat. The laser light-emitting device 41 is cooled by a cooling unit 50 as cooling means. Furthermore, use of the fiber array unit 14b for the laser irradiation device 14 of this embodiment allows the laser light-emitting devices 41 to be disposed remote from one another. This allows a laser light-emitting device 41 to be less affected by heat of the next laser light-emitting device 41, which thus allows efficient cooling of the laser light-emitting device 41 and therefore allows avoiding an increase and variation in the temperature of the laser light-emitting devices 41, reducing variation in the power output of laser light, and suppressing the density unevenness and void. Power output of laser light is average power output measured by a power meter. A method of controlling power output of laser light is classed into two groups. One of the groups controls peak power, and the other controls luminous efficacy of a pulse (the duty ratio: laser luminous time/total period).

The cooling unit 50 uses liquid cooling that circulates coolant to cool the laser light-emitting devices 41. The cooling unit 50 includes a heat-receiving unit 51 where the coolant receives heat from the laser light-emitting devices 41, and a heat-dissipation unit 52 to dissipate heat of the coolant. The heat-receiving unit 51 and the heat-dissipation unit 52 are connected with each other by cooling pipes 53a and 53b. The heat-receiving unit 51 includes a case and a cooling tube for the coolant to flow therethrough, both of which being made of a material with high thermal conductivity, and the cooling tube is accommodated in the case. A plurality of laser light-emitting devices 41 are arrayed on the heat-receiving unit 51.

The heat-dissipation unit 52 includes a radiator and a pump to circulate the coolant. The coolant pumped by the pump of the heat-dissipation unit 52 travels the cooling pipe 53a and flows into the heat-receiving unit 51. The coolant traveling the cooling tube inside the heat-receiving unit 51 draws heat from the laser light-emitting devices 41 arrayed on the heat-receiving unit 51 and cools the laser light-emitting devices 41. The coolant having the temperature increased by drawing heat of the laser light-emitting devices 41 through the heat-receiving unit 51 travels the cooling pipe 53b to the radiator of the heat-dissipation unit 52 and is cooled by the radiator. The coolant is cooled by the radiator and is pumped again to the heat-receiving unit 51.

The fiber array unit 14b includes a plurality of optical fibers 42 prepared for respective laser light-emitting devices 41 and an array head 44 holding the optical fibers 42 at near the laser discharge portions 42a. Specifically, the optical fibers 42 are arrayed in the vertical direction (the Z-axis direction) and held by the array head 44. A laser incident portion of each optical fiber 42 is attached to a laser discharge surface of the corresponding laser light-emitting device 41.

If all the optical fibers 42 are designed to be held by one array head 44, the array head 44 needs to be sufficiently long and is therefore easily deformed. In this case, use of one array head 44 has difficulty in maintaining straight arrangement of beams and in keeping the beam pitch constant. The array head 44 is therefore designed to hold one hundred to two hundred optical fibers 42. The laser irradiation device 14 preferably has a plurality of array heads 44, each of which holds one hundred to two hundred optical fibers 42, arrayed in the Z-axis direction intersecting with the moving direction of the thermosensitive recording label RL. In this embodiment, two hundred array heads 44 are arranged in the Z-axis direction.

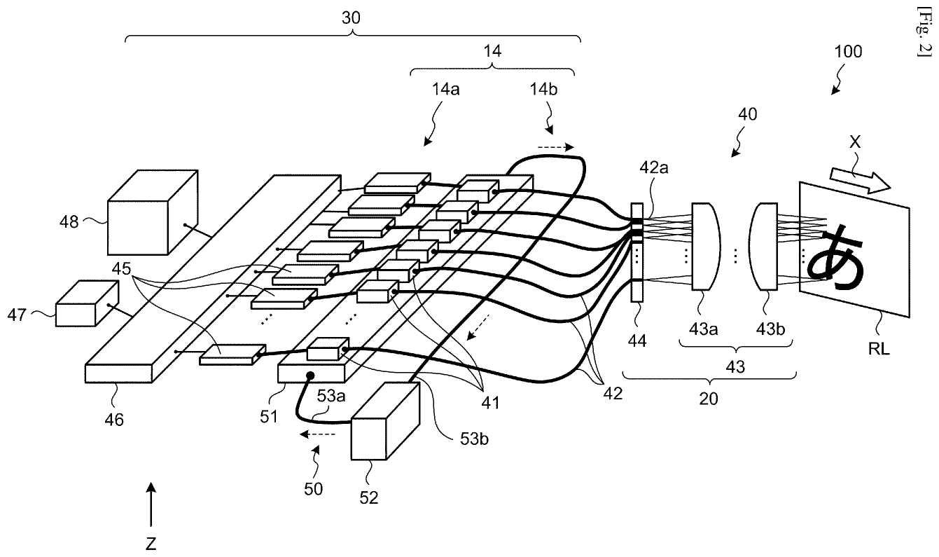

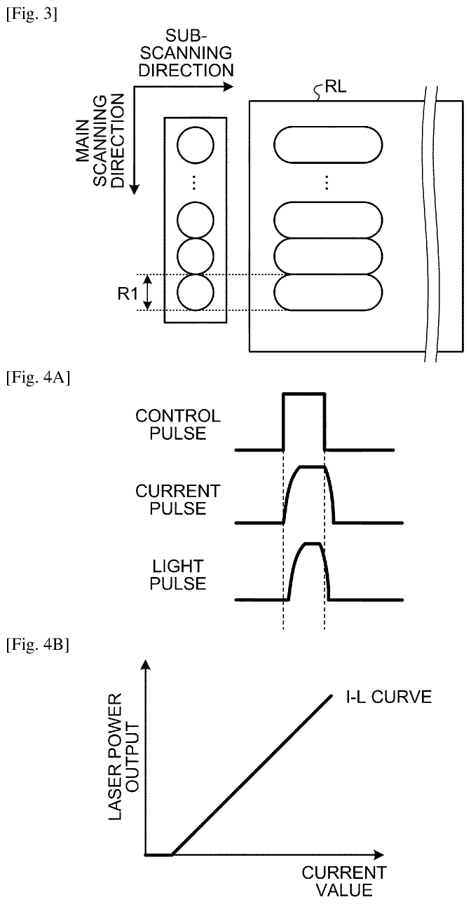

FIG. 3 is a view illustrating the geometry of a laser array. As illustrated in FIG. 3, the optical fibers 42 are arranged on the array head 44 such that the diameters of dots R1, formed by irradiating the thermosensitive recording medium RL with laser beams to develop color, are continuous with one another at a focal point where light is collected by the optical unit 43.

The direction of scanning of laser light includes a main scanning direction and a sub-scanning direction, and the main scanning direction and the sub-scanning direction intersect with each other. The main scanning direction is a direction in which a plurality of optical fibers 42 are arrayed. The sub-scanning direction is a direction in which the thermosensitive recording label RL moves.

An image is recorded on the thermosensitive recording label RL while moving the array head 44 and the thermosensitive recording label RL relative to each other, and thus the array head 44 may be moved relative to the thermosensitive recording label RL, or the thermosensitive recording label RL may be moved relative to the array head 44. In the case where the array head 44 is moved relative to the thermosensitive recording label RL, the expression “the moving speed of the thermosensitive recording label RL” can be used when regarding the array head 44 as an observation point.

As illustrated in FIG. 2, the optical unit 43 as an example of optical series includes a collimator lens 43a for converting divergent beams of laser light discharged from the optical fibers 42 into parallel beams and a condenser lens 43b for condensing laser light to the surface of the thermosensitive recording label RL to be irradiated with laser light. Necessity of disposing the above optical unit 43 may be determined based on the purpose.

The image information output unit 47 such as a personal computer inputs image information to the controller 46. The controller 46 creates a drive signal (control pulse) to drive actuation drivers 45 based on the input image information. The controller 46 transmits the created drive signal (control pulse) to the actuation drivers 45. More specifically, the controller 46 includes a clock generator and transmits a drive signal (control pulse) to drive the actuation driver 45 to each of the actuation drivers 45 when the number of clock signals produced by the clock generator reaches a predetermined number.

Upon receipt of the drive signal (control pulse), the actuation driver 45 transmits a current pulse and actuates the corresponding laser light-emitting device 41. In response to drive of the actuation driver 45, the laser light-emitting device 41 outputs a light pulse and emits laser light. The laser light emitted from the laser light-emitting device 41 enters the corresponding optical fiber 42 and is output from a laser discharge portion 42a of the optical fiber 42. The laser light output from the laser discharge portion 42a of the optical fiber 42 permeates through the collimator lens 43a and the condenser lens 43b of the optical unit 43 and is applied to the surface of the thermosensitive recording label RL as a recording object. The laser light applied to the surface of the thermosensitive recording label RL heats the surface thereof, which allows images to be recorded on the surface of the thermosensitive recording label RL.

FIGS. 4A and 4B are diagrams for explaining the relation between a control pulse and a light pulse. FIG. 4A is a timing diagram of the control pulse and the light pulse. FIG. 4B illustrates an I-L characteristic of a laser. As illustrated in FIGS. 4A and 4B, the rise of the light pulse is a little delayed from that of the current pulse. This delay is caused because the laser emits no light before current at a certain level is applied, as seen from the I-L characteristic indicating correlation between laser output and a current value.

In use of a recording device that records images on a recording object by using galvano mirrors and polarizing laser light, an image such as a letter is recorded by applying laser light to the object, in a manner of drawing a continuous line with each galvano mirror rotated. Therefore, there is a restriction that, when a certain amount of information is recorded on a recording object, the recording object being conveyed needs to be stopped in order to make the recording work.

The laser irradiation device 14 using a laser array where a plurality of laser light-emitting devices 41 are arrayed can record images on the thermosensitive recording label RL by switching on and off the laser light-emitting devices for respective pixels. This allows an image having a larger amount of information to be recorded on the thermosensitive recording label RL without stopping conveyance of the thermosensitive recording label RL. The laser irradiation device 14 is therefore capable of recording an image having a large amount of information on a recording object without reducing manufacturing productivity.

Since the laser irradiation device 14 irradiates the thermosensitive recording label RL with laser light and heats the thermosensitive recording label RL to record images thereon, the laser irradiation device 14 needs to include laser light-emitting devices 41 capable of outputting high power to a certain extent. The laser light-emitting device 41 therefore produces a large amount of heat. A conventional laser array recording device having no fiber array units 14b therefore needs to array the laser light-emitting devices 41 at intervals determined based on the resolution. Such a conventional laser array recording device therefore needs to array the laser light-emitting devices 41 at quite small pitches to obtain resolution of 200 dpi. The geometry of the conventional laser array recording device makes heat of the laser light-emitting device 41 less dissipated, which increases the temperature of the laser light-emitting device 41. With the conventional laser array recording device, an increase in the temperature of the laser light-emitting device 41 changes the wavelength and optical power output of the laser light-emitting device 41. The conventional laser array recording device therefore has difficulty in heating the recording object to a predetermined temperature and thus cannot obtain a satisfactory quality image. In addition, in the conventional laser array recording device, to suppress an increase in the temperature of the laser light-emitting device 41 as described above, the moving speed of the recording object should be reduced and a certain light emission interval of laser light-emitting device 41 should be secured, which prevents increase of manufacturing productivity.

A chiller system is usually used for the cooling unit 50. In this embodiment, the cooling unit 50 does not provide heating but only provide cooling. The temperature of the light source does not exceed a set temperature of the chiller, however, the temperatures of the cooling unit 50 and the laser light-emitting device 41 contacting the cooling unit fluctuate with the ambient temperature. In use of a semiconductor laser for the laser light-emitting device 41, laser power output is changed with a change in the temperature of the laser light-emitting device 41 (in other words, laser power output is increased with a reduction in the temperature of the laser light-emitting device 41). For normal image formation, laser power output is therefore preferably controlled by measuring the temperature of the laser light-emitting device 41 or the temperature of the cooling unit 50 and controlling an input signal to the actuation driver 45, which provides control to maintain laser power output constant, based on the measured temperature.

The laser irradiation device 14 is a fiber array recording device with the fiber array unit 14b. By using the fiber array recording device, it becomes enough to arrange the laser discharge portions 42a of the fiber array unit 14b at appropriate pitches based on the image resolution, and there is therefore no necessity of adjusting the pitches between the laser light-emitting devices 41 of the laser array unit 14a to pitches based on the resolution. Therefore, according to the laser irradiation device 14, heat of the laser light-emitting devices 41 can be sufficiently dissipated, and thus pitches between the laser light-emitting devices 41 can be made adequately wide. Then, according to the laser irradiation device 14, it is possible to prevent the temperature of the laser light-emitting devices 41 from reaching high and reduce fluctuation in the wavelength and optical power output of the laser light-emitting devices 41. The laser irradiation device 14 is therefore capable of recording satisfactory quality image on the thermosensitive recording label RL. Further, according to the laser light-emitting devices 41, an increase in the temperature of the laser light-emitting devices 41 can be suppressed even if light emission interval is reduced, which enables increasing the moving speed of the thermosensitive recording label RL, and improving manufacturing productivity.

The laser irradiation device 14 includes the cooling unit 50 and cools the laser light-emitting devices 41 with a liquid, and thus, an increase in the temperature of the laser light-emitting devices 41 can be further suppressed. As a result, according to the laser irradiation device 14, light emission interval of the laser light-emitting devices 41 can be further reduced, which enables increasing the moving speed of the thermosensitive recording label RL, and accordingly improving manufacturing productivity. The laser irradiation device 14 cools the laser light-emitting devices 41 with a liquid, but the laser light-emitting devices 41 may be cooled with air using a cooling fan or the like. Compared to air cooling, liquid cooling is advantageous in efficient cooling and is capable of smoothly cooling the laser light-emitting device 41. Air cooling is less efficient than liquid cooling; however, it is advantageous in cooling the laser light-emitting device 41 at a lower cost.

The process of printing on the thermosensitive recording label RL in the rest state will now be described.

FIG. 5 is a diagram for explaining printing on the thermosensitive recording label RL in the rest state. While the thermosensitive recording label RL is in the rest state, the laser light-emitting device 41 continuously irradiates a laser spot with laser light. The laser light emitted from the laser light-emitting device 41 is transmitted to the thermosensitive recording label RL as thermal energy. As illustrated in FIG. 5, the thermal energy has Gaussian distribution that has a peak at the center and has low ends.

As illustrated in FIG. 5, the thermosensitive recording label RL has a color development threshold. In the graph, the area above the color development threshold develops color. The color optical density is proportional to the magnitude of thermal energy. The color development threshold differs between materials of the thermosensitive recording label RL.

The process of printing on a moving thermosensitive recording label RL will now be described.

FIG. 6 is a diagram for explaining printing on a moving thermosensitive recording label RL. When laser light is emitted from the laser light-emitting device 41 onto the moving thermosensitive recording label RL, the spot irradiated with laser light accordingly moves. In FIG. 6, the thermosensitive recording label RL is conveyed with laser power output maintained constant and with thermal energy, applied to the thermosensitive recording label RL per unit diameter of an irradiated spot, maintained constant. As illustrated in FIG. 6, even when the color development threshold is not exceeded with a single spot, thermal energy is accumulated at a part where spots overlap if the spots overlap so that the color development threshold is exceeded and color is developed.

Electrical connection of the image recording system 100 will now be described.

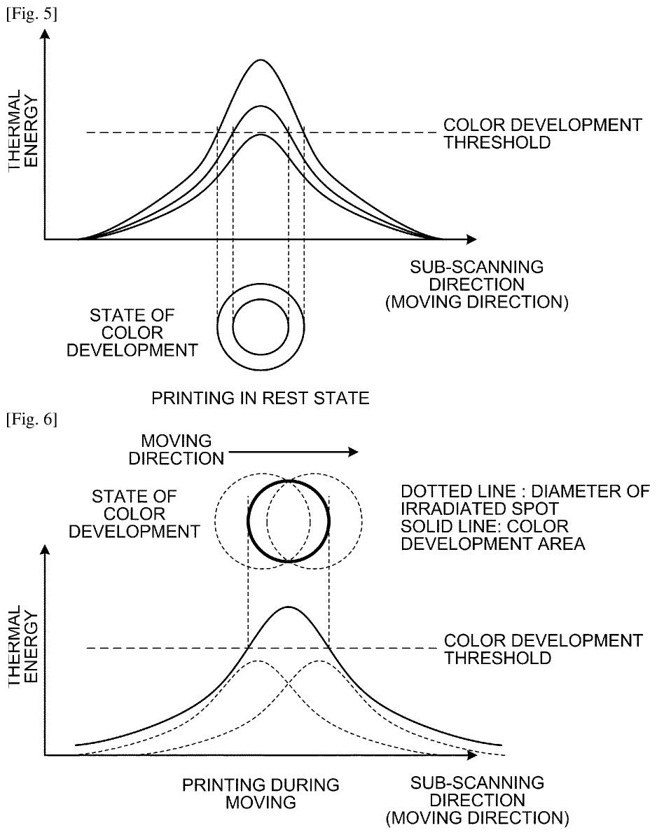

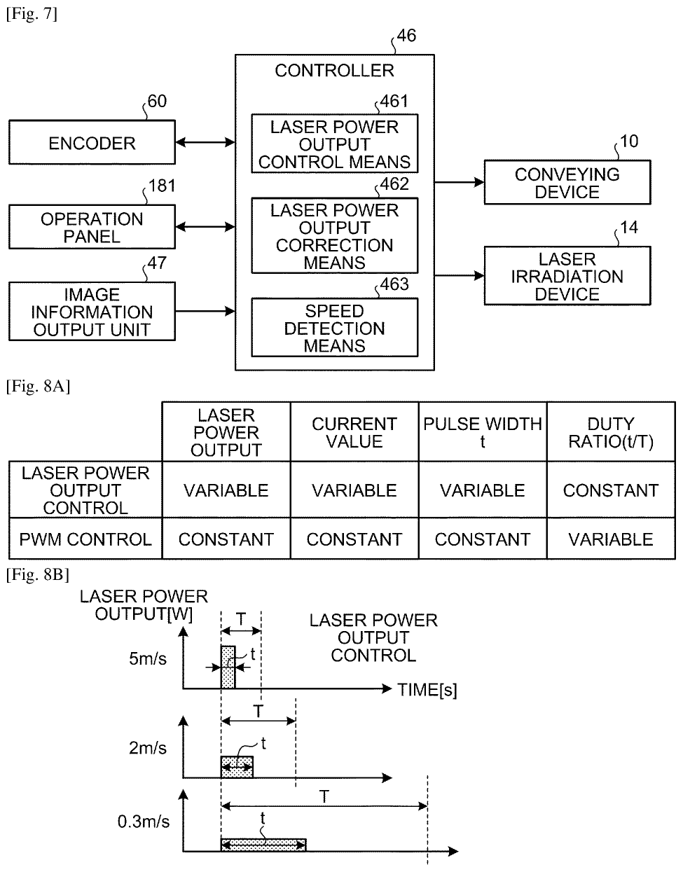

FIG. 7 is a block diagram illustrating a part of an electrical circuit of the image recording system 100. As illustrated in FIG. 7, the controller 46 includes a central processing unit (CPU), a random access memory (RAM), a read only memory (ROM) to store a computer program or the like, and a non-volatile memory to store a computer program or the like. For example, the controller 46 controls drive of the devices of the image recording system 100 and performs various types of arithmetic processing. The controller 46 is connected with the conveying devices 10, the laser processing device 40, the encoder 60, an operation panel 181, the image information output unit 47, and other units.

The operation panel 181 has a touchscreen display and various types of keys, and displays images and receives various types of information input through key operation of an operator.

As illustrated in FIG. 7, the controller 46 functions as laser power output control means 461, laser power output correction means 462, and speed detection means 463 with the CPU operating in accordance with computer programs stored in the ROM and the non-volatile memory.

The speed detection means 463 detects the moving speed of the thermosensitive recording label RL with the location of the laser irradiation device 14 when laser light is emitted from the laser light source, as an observation point, while moving at least one of the thermosensitive recording label RL as a recording object and the laser irradiation device 14 as a laser light source.

The laser power output control means 461 changes the power output of laser light emitted from the laser irradiation device 14 based on the moving speed of the thermosensitive recording label RL as a recording object and maintains the amount of energy per unit area applied to the thermosensitive recording label RL constant.

Even when the amount of energy per unit area applied to the thermosensitive recording label RL is maintained constant, the level of thermal diffusion (energy loss) affecting the power output of laser light applied to the thermosensitive recording label RL varies depending on the moving speed, which results in variation in the color optical density of the thermosensitive recording label RL. The laser power output correction means 462 therefore corrects the power output of laser light emitted from the laser irradiation device 14 based on the moving speed of the thermosensitive recording label RL to compensate such variation in the color optical density.

A computer program executed by the image recording system 100 of this embodiment is stored in a computer-readable memory medium such as a compact disc read only memory (CD-ROM), a flexible disk (FD), a compact disc recordable (CD-R), and a digital versatile disc (DVD) as an installable or executable file and is provided.

The computer program executed by the image recording system 100 of this embodiment may be stored in a computer connected to a network such as the Internet and provided by being downloaded via the network. The computer program executed by the image recording system 100 of this embodiment may be provided or distributed via a network such as the Internet.

The computer program executed by the image recording system 100 of this embodiment may be embedded in a ROM or the like and provided.

An energy control scheme for laser printing will now be described.

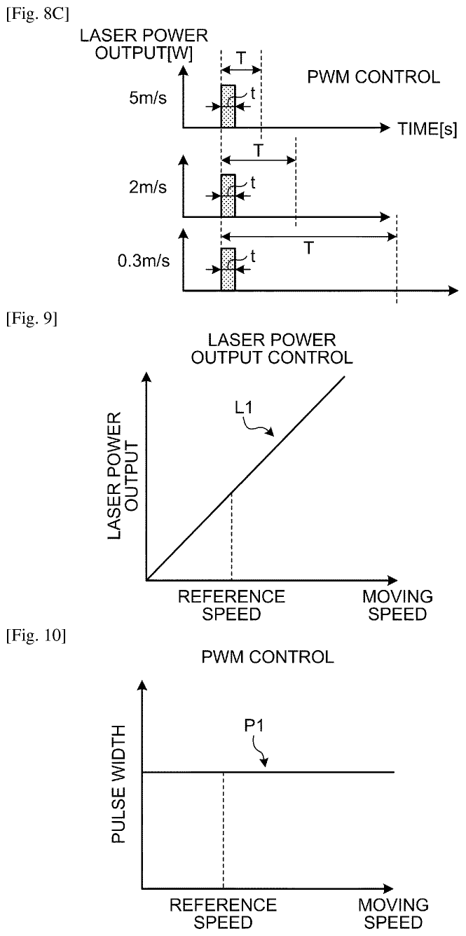

FIGS. 8A to 8C are diagrams for explaining an energy control scheme for laser printing. The six graphs illustrated in FIGS. 8A to 8C are based on the same amount of energy. An energy control scheme for laser printing is classed into a laser power output control scheme (a first control scheme) illustrated in FIG. 8B and a pulse width modulation (PWM) control scheme (a second control scheme) illustrated in FIG. 8C.

The laser power output control scheme will now be described.

As illustrated in FIG. 8A and FIG. 8B, the laser power output control scheme synchronizes the pulse width t [s], indicating the time for actual printing, to the period T [s] to print one dot and makes the duty ratio (t/T) of the pulse width t [s] to the period T [s] of laser power output constant. In printing one dot of a certain size by the laser power output control scheme, an increase in the moving speed v [m/s] reduces the period T, whereas a decrease in the moving speed v increases the period T. In the laser power output control scheme, a change in the moving speed v changes the period T, which accordingly changes the pulse width t.

In the laser power output control scheme, energy per unit area E1 [J] is given by: E1=L/(v·d), where L is laser power output L [w], and d is the diameter of a beam d [m]. The laser power output therefore varies.

Since the laser power output is correlated with a current value with the I-L characteristic, the laser power output control scheme changes the current value to change the laser power output.

As illustrated in FIG. 8A and FIG. 8C, the PWM control scheme fixes the energy E1 per unit area by making the laser power output L and the pulse width t constant, regardless of the period T [s] to print one dot. In the PWM control scheme, a change in the moving speed changes the period T, which accordingly changes the duty ratio (t/T). In other words, the PWM control scheme maintains the laser power output L [w] and the pulse width t [s] constant, while allowing the duty ratio (t/T) of the pulse width t [s] to the period T [s] of laser power output to vary.

The following describes the relation between the laser power output and the color optical density on the thermosensitive recording label RL.

On the thermosensitive recording label RL, the color optical density is proportional to the magnitude of thermal energy, in other words, proportional to the laser power output for writing. For maintaining consistency in the quality of recording such as writing, it is necessary to maintain the power output of laser light, emitted from the laser light-emitting device 41, constant per unit area of recording on the thermosensitive recording label RL. In this case, the area of recording corresponds to one dot as a smallest unit of recording.

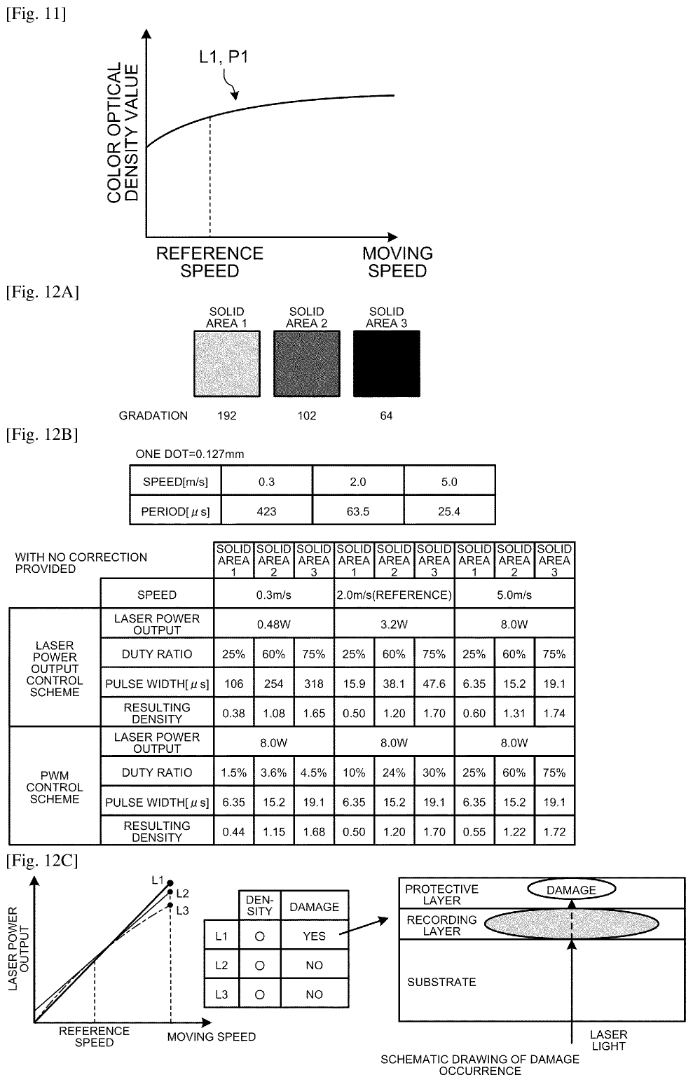

FIG. 9 is a graph that illustrates the relation between laser power output to the thermosensitive recording label RL and the moving speed. FIG. 10 is a graph that illustrates the relation between a pulse width to the thermosensitive recording label RL and the moving speed. FIG. 11 is a graph that illustrates the relation between the color optical density value and the moving speed of the thermosensitive recording label RL.

As described above, the energy per unit area E1 [J] applied to the thermosensitive recording label RL is given by: E1=L/(v·d) . . . (1), where L is the laser power output L [w], v is the moving speed v [m/s] of the thermosensitive recording label RL, and d is the diameter d [m] of a beam.

As indicated by L1 of FIG. 9, the laser power output control scheme is capable of fixing the energy E1 per unit area applied to the thermosensitive recording label RL by linearly varying the laser power output with the moving speed of the thermosensitive recording label RL. As indicated by P1 of FIG. 10, the PWM control scheme is capable of fixing the energy E1 per unit area applied to the thermosensitive recording label RL by maintaining the laser power output and the pulse width constant.

Such manners that only fix the energy E1 per unit area, however, problematically cause subtle difference in color optical density as illustrated in FIG. 11, because the level of thermal diffusion affecting the energy applied to the thermosensitive recording label RL varies with the moving speed of the thermosensitive recording label RL. This will be more specifically described.

Basically, not all the power output of laser light emitted from a laser light source onto a thermosensitive recording medium as a recording object is always used for recording processing such as writing. A part of the power output of laser light applied to the thermosensitive recording medium through irradiation is dissipated to the periphery of the irradiated area, which phenomenon is called thermal diffusion, and the dissipated power is not used as energy for recording processing such as writing. The thermal diffusion is accounted as a value that stays unchanged for a change in the moving speed v [m/s] of the thermosensitive recording label RL.

As indicated by the above formula (1), where the energy per unit area applied to the thermosensitive recording label RL is represented by E1 [J], the laser power output by L [w], the moving speed of the thermosensitive recording label RL by v [m/s], and the diameter of a beam by d [m], an increase in the moving speed v [m/s] of the thermosensitive recording label RL increases the laser power output L [w], which allows the energy E1 [J] per unit area applied to the thermosensitive recording label RL to be constant.

With regard to the effect of thermal diffusion to the laser power output L [w], a decrease in the moving speed v [m/s] of the thermosensitive recording label RL decreases the laser power output L [w], and an increase in the speed increases the laser power output L [w]. The laser power output L [w] is therefore subjected to a higher level of thermal diffusion in the low moving speed area than in the high moving speed area of the thermosensitive recording label RL. In other words, variation in the color optical density derived from thermal diffusion (energy loss due to thermal diffusion to the laser power output L [w]) is more significant in the low moving speed area of the thermosensitive recording label RL.

Considering the above effect of thermal diffusion to the laser power output L [w], simply linearly changing the laser power output, with a change in the moving speed of the thermosensitive recording label RL, is not a sufficiently effective measure.

In this embodiment, the laser power output is corrected based on the moving speed of the thermosensitive recording label RL to prevent variation in the color optical density, the variation resulting from thermal diffusion on the thermosensitive recording label RL.

FIGS. 12A to 12C illustrate results of printing with no correction provided. FIG. 12A illustrates first to third solid areas on the thermosensitive recording label RL, the density of which is, respectively, thin (192 of 256 gradations), middle (102 of 256 gradations), and completely thick (64 of 256 gradations). FIG. 12B illustrates the relation between the moving speed and the color optical density in each of the laser power output control scheme and the PWM control scheme. In FIG. 12B, the reference moving speed of the thermosensitive recording label RL is set at 2.0 m/s. It is an object of this embodiment to make the color optical density value (an OD value) of a solid area in each moving speed close to the color optical density value of the same in the reference moving speed.

Because the purpose is to make the color optical density value (an OD value) similar at any moving speed to improve the production yield, the reference moving speed is set almost in the middle between the lowest speed and the highest speed. This enables suppressing variation between the reference moving speed and the lowest moving speed and between the reference moving speed and the highest moving speed as much as possible.

FIG. 12C illustrates conditions when damage occurs. As illustrated in FIG. 12C, in the high moving speed area with no correction provided (L1), the laser power output control scheme can maintain the density desirable, however, unlike the conditions with correction provided (L2 and L3), the scheme suffers from damage to the thermosensitive recording label RL. Since the laser power output L [w] is less affected by thermal diffusion (the energy loss is small) in the high moving speed area, larger power is intensively applied to a spot. The protective layer is therefore likely to get damaged by heat and to be removed. The correction is therefore necessary also to solve this problem.

Exemplary energy correction processing will now be described.

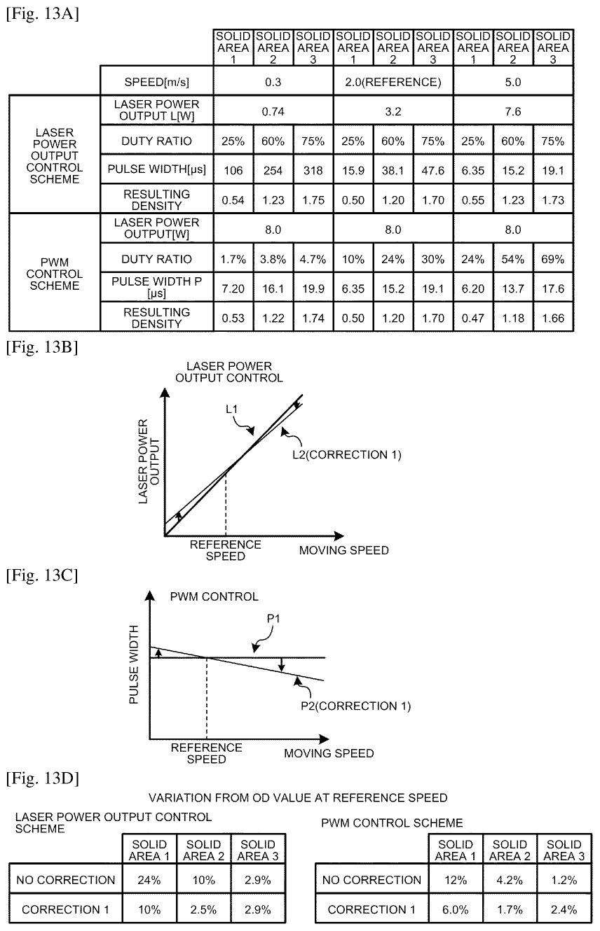

FIGS. 13A to 13D are diagrams for explaining an example of energy correction processing according to the first embodiment. The exemplary energy correction of this embodiment is applied to both the laser power output control scheme and the PWM control scheme using the following formulae.

The laser power output control scheme . . . L=L₀+β₁((v₀−v)/v₀)
The PWM control scheme . . . P=P₀+β₂((v₀−v)/v₀)
v₀ [m/s]: the reference moving speed
v [m/s]: a moving speed
L₀ [W]: the laser power output value at the reference moving speed v₀ [m/s]
P₀ [μs]: the pulse width at the reference moving speed v₀ [m/s]
L [W]: the laser power output value at a moving speed v₀ [m/s]
P [μs]: the pulse width at a moving speed v [m/s]
β₁, β₂: a coefficient of correction

FIG. 13 A is a table that illustrates the relation between the moving speed and the color optical density in each of the laser power output control scheme and the PWM control scheme with correction provided. FIG. 13B is a graph that illustrates the relation between the laser power output to the thermosensitive recording label RL and the moving speed with correction provided and with no correction provided. FIG. 13C is a graph that illustrates the relation between the pulse width to the thermosensitive recording label RL and the moving speed with correction provided and with no correction provided.

FIG. 13A gives resulting color optical density values (OD values) of solid areas (see FIG. 12A) with correction provided. The coefficients β₁ and β₂ differ depending on materials of the thermosensitive recording label RL. In the graph of FIG. 13A, the laser power output and the pulse width are calculated using β₁=0.3, and β₂=1.0×10⁻⁶.

In the laser power output control scheme subjected to the above correction, the relation between the corrected laser power output to the thermosensitive recording label RL and the moving speed is given as L2 in FIG. 13B. In the PWM control scheme subjected to the above correction, the relation between the corrected pulse width to the thermosensitive recording label RL and the moving speed is given as P2 in FIG. 13C.

Since it is an object to improve the production yield by maintaining the color optical density value (an OD value) substantially constant at a variable speed, the reference moving speed v₀ [m/s] is set at around the middle of the lowest speed and the highest speed. This achieves as small variation in the color optical density between the reference moving speed and the lowest moving speed as possible, and likewise, achieves as small variation in the color optical density between the reference moving speed and the highest moving speed as possible.

The tables of FIG. 13D illustrate variation in the color optical density value (OD value) with respect to the color optical density at the reference moving speed, in the laser power output control scheme and the PWM control scheme. More specifically, the data is indicated for the cases with correction provided and with no correction provided for each of the solid areas (see FIG. 12A). The values on the table of FIG. 13D are given by comparing the color optical density value at the reference moving speed (2.0 m/s) with the color optical density value at each of the predetermined moving speeds (0.3 m/s and 5.0 m/s), and of the optical density values at the predetermined moving speeds (0.3 m/s and 5.0 m/s), selecting either one having a larger variation.

As illustrated in FIG. 13D, the largest variation in the color optical density value (OD value) with no correction provided is 24% in the laser power output control scheme and 12% in the PWM control scheme. By contrast, it can be seen that the largest variation in the color optical density value (OD value) with correction (first correction) provided is reduced to 10% in the laser power output control scheme and to 6.0% in the PWM control scheme.

As described above, the effect of thermal diffusion (energy loss) to the power output of laser light, emitted onto the thermosensitive recording label RL, varies with the moving speed, which results in variation in the color optical density of the thermosensitive recording label RL. The following describes printing processing including processing to correct such variation in the color optical density.

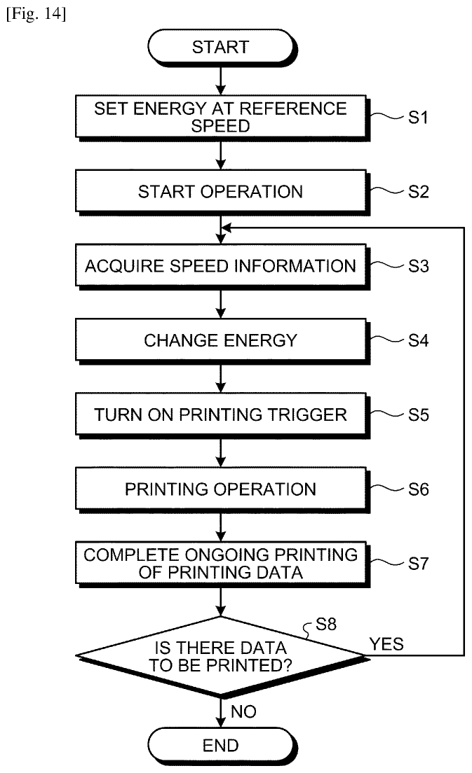

FIG. 14 is a flowchart that schematically illustrates a flow of printing processing of the controller 46. As illustrated in FIG. 14, the controller 46 selects the reference moving speed and, based on the speed, sets the most suitable amount of energy (Step S1). In Step S1 to set the most suitable amount of energy, the controller 46 fixes energy E1 per unit area, to be applied to the thermosensitive recording label RL, by multiplying the energy by a suitable coefficient of energy correction.

The controller 46 instructs to start a printing operation (Step S2).

Right before the start of printing, the controller 46 acquires moving speed data (information of speed) of the thermosensitive recording label RL from the encoder 60 (Step S3).

Based on the moving speed data (information of speed) acquired at Step S3, the controller 46 performs energy correction processing to change the amount of energy (Step S4).

The controller 46 starts printing by turning on a printing trigger (Step S5). The printing trigger starts soon after being turned on.

The controller 46 starts printing at the amount of energy set at Step S4 (Step S6).

Upon completion of printing operation for printing data of ongoing printing (Step S7), the controller 46 determines the presence or absence of data to be subsequently printed (Step S8).

In the presence of data to be subsequently printed (Yes at Step S8), the controller 46 returns the process back to Step S3 and acquires the moving speed data (information of speed) of the thermosensitive recording label RL from the encoder 60.

In the absence of data to be subsequently printed (No at Step S8), the controller 46 ends the operation.

### Second Embodiment

A second embodiment will now be described.

The image recording system 100 of the second embodiment differs from that of the first embodiment in the manner of energy correction processing. The manner described in the first embodiment still has large variation left in the color optical density value (OD value) in both the low speed area and the high speed area. The following description of the second embodiment will omit the same part as the first embodiment and focus on the parts different from the first embodiment.

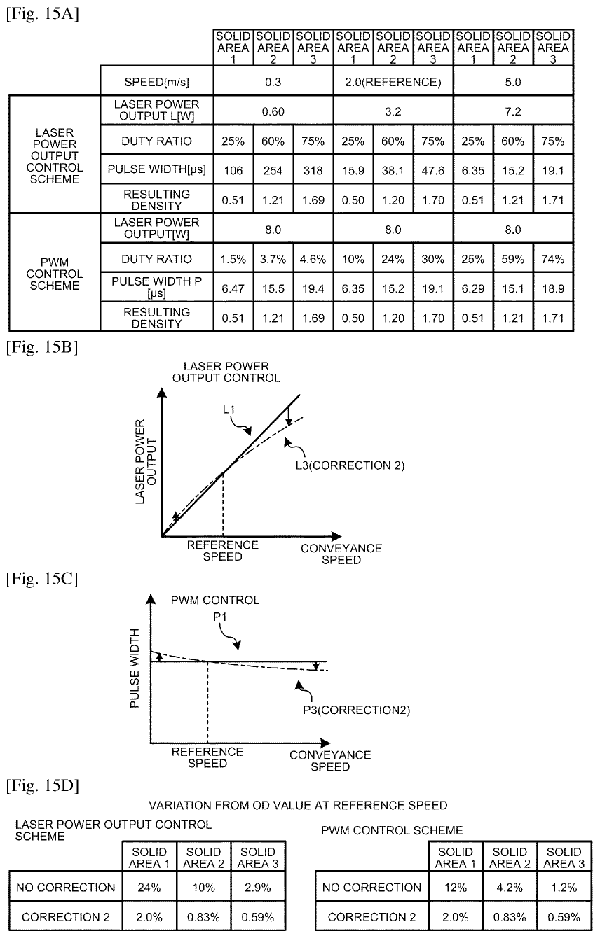

FIGS. 15A to 15D are diagrams for explaining an example of energy correction processing according to the second embodiment. The exemplary energy correction of this embodiment is applied to both the laser power output control scheme and the PWM control scheme using the following formulae.

The laser power output control scheme . . . L=L₀×(v/v₀)^{α1}

The PWM control scheme . . . P=β₀×(v₀/v)^{α2}

v₀ [m/s]: the reference moving speed

v [m/s]: a moving speed

L₀ [W]: the laser power output value at the reference moving speed v₀ [m/s]

P₀ [μs]: the pulse width at the reference moving speed v₀ [m/s]

L [W]: the laser power output value at a moving speed v [m/s]

P [μs]: the pulse width at a moving speed v [m/s]

α₁, α₂: a coefficient of correction

FIG. 15A is a table that illustrates the relation between the moving speed and the color optical density in each of the laser power output control scheme and the PWM control scheme with correction provided. FIG. 15B is a graph that illustrates the relation between the laser power output to the thermosensitive recording label RL and the color optical density with correction provided and with no correction provided. FIG. 15C is a graph that illustrates the relation between the pulse width to the thermosensitive recording label RL and the color optical density with correction provided and with no correction provided.

FIG. 15A illustrates resulting optical density values (OD values) of solid areas (see FIG. 12A) with correction provided. The coefficients α₁ and α₂ differ depending on materials of the thermosensitive recording label RL. In the table of FIG. 15A, the laser power output and the pulse width are calculated using α₁=0.88 and α₂=0.01.

In the laser power output control scheme subjected to the above correction, the relation between the corrected laser power output to the thermosensitive recording label RL and the moving speed is given as L3 in FIG. 15B. In the PWM control scheme subjected to the above correction, the relation between the corrected pulse width to the thermosensitive recording label RL and the moving speed is given as P3 in FIG. 15C.

The tables of FIG. 15D illustrate variation in the color optical density value (OD value) with respect to the color optical density at the reference moving speed, in the laser power output control scheme and the PWM control scheme. More specifically, the data is indicated for the cases with correction provided and with no correction provided for each of the solid areas (see FIG. 12A). The values on the tables of FIG. 15D are given by comparing the color optical density value at the reference moving speed (2.0 m/s) with the color optical density value at each of the predetermined moving speeds (0.3 m/s and 5.0 m/s), and of the optical density values at the predetermined moving speeds (0.3 m/s and 5.0 m/s), selecting either one having a larger variation.

As illustrated in FIG. 15D, the largest variation in the color optical density value (OD value) with no correction provided is 24% in the laser power output control scheme and 12% in the PWM control scheme, whereas the largest variation in the color optical density value (OD value) with correction (second correction) provided is effectively reduced to 2.0% in the laser power output control scheme and to 2.0% in the PWM control scheme.

In comparison with the results of FIG. 13D of the first embodiment, the variation in the color optical density value (OD value) with correction provided are effectively reduced as illustrated in FIG. 15D.

The laser power output is set to maintain the amount of energy per unit area, applied to a recording object, constant for a change in the relative speed between the recording object and a laser light source. According to the first and the second embodiments, energy loss derived from thermal diffusion, occurring on the recording object and affecting the laser power output, is compensated based on the relative speed. The moving speed of the recording object increases from a low speed, in start of moving, to a high speed, in steady operation, and decreases from the high speed in the steady operation to the low speed to stop moving. According to the embodiments, consistency in the quality of recording including writing to the recording object is maintained by reducing the effect of such variation in the moving speed of the recording object.

### REFERENCE SIGNS LIST

40 Laser light source
100 Laser recording device
461 Laser power output control means
462 Laser power output correction means
RL Recording object

### CITATION LIST

### Patent Literature

PTL 1: Japanese Laid-open Patent Publication No. 2013-248636

1. A laser recording method for processing a recording object with laser light emitted from a laser light source, the laser recording method comprising:
detecting a moving speed of the recording object with a location of the laser light source when the laser light source emits laser light, as an observation point, while moving at least one of the recording object and the laser light source; and
correcting power output of the laser light set such that an amount of energy applied by the laser light per unit area of the recording object is constant even if the moving speed is changed, to compensate energy loss derived from thermal diffusion occurring on the recording object based on the moving speed detected at the detecting.

2. The laser recording method according to claim 1, wherein, in a case of a first control scheme that maintains a duty ratio (t/T) of a pulse width t [s] to a laser power output period T [s] constant, the power output of the laser light is corrected at the correcting, using the following formula:
L=L₀+β₁((v₀−v)/v₀),
where
v₀ [m/s]: a reference moving speed,
v [m/s]: a moving speed,
L₀ [W]: a laser power output value at the reference moving speed v₀ [m/s],
L [W]: a laser power output value at the moving speed v [m/s], and
β₁: a coefficient of correction.

3. The laser recording method according to claim 1, wherein, in a case of a second control scheme that maintains laser power output L[w] and a pulse width t [s] constant and allows a duty ratio (t/T) of a pulse width t [s] to a laser power output period T [s] to vary, the power output of the laser light is corrected at the correcting, using the following formula:
P=β₀+β₂((v₀−v)/v₀),
where
v₀ [m/s]: a reference moving speed,
v [m/s]: a moving speed,
P₀ [μs]: a pulse width at the reference moving speed v₀ [m/s],
P [μs]: a pulse width at the moving speed v [m/s], and
β₂: a coefficient of correction.

4. The laser recording method according to claim 1, wherein, in a case of a first control scheme that maintains a duty ratio (t/T) of a pulse width t [s] to a laser power output period T [s] constant, the power output of the laser light is corrected at the correcting, using the following formula:
L=L₀×(v/v₀)^{α1},
where
v₀ [m/s]: a reference moving speed,
v [m/s]: a moving speed,
L₀ [W]: a laser power output value at the reference moving speed v₀ [m/s],
L [W]: a laser power output value at the moving speed v [m/s], and
α₁: a coefficient of correction.

5. The laser recording method according to claim 1, wherein, in a case of a second control scheme that maintains laser power output L [w] and a pulse width t [s] constant and allows a duty ratio (t/T) of a pulse width t [s] to a laser power output period T [s] to vary, the power output of the laser light is corrected at the correcting, using the following formula:
P=P₀(v₀/v)^{α2},
where
v₀ [m/s]: a reference moving speed,
v [m/s]: a moving speed,
P₀ [μs]: a pulse width at the reference moving speed v₀ [m/s],
P [μs]: a pulse width at the moving speed v [m/s], and
α₂: a coefficient of correction.

6. The laser recording method according to claim 2, wherein at the correcting, a reference moving speed is set in a middle between a lowest speed and a highest speed.

7. A laser recording device configured to process a recording object with laser light emitted from a laser light source, the laser recording device comprising:
a speed detector configured to detect a moving speed of the recording object with a location of the laser light source when the laser light source emits laser light, as an observation point, while moving at least one of the recording object and the laser light source; and
a laser power output corrector configured to correct power output of the laser light set such that an amount of energy applied by the laser light per unit area of the recording object is constant even if the moving speed is changed, to compensate energy loss derived from thermal diffusion occurring on the recording object based on the moving speed detected by the speed detector.

8. The laser recording device according to claim 7, wherein, in a case of a first control scheme that maintains a duty ratio (t/T) of a pulse width t [s] to a laser power output period T [s] constant, the laser power output corrector is configured to correct the power output of the laser light using the following formula:
L=L₀+β₁((v₀−v)/v₀),
where
v₀ [m/s]: a reference moving speed,
v [m/s]: a moving speed,
L₀ [W]: a laser power output value at the reference moving speed v₀ [m/s],
L [W]: a laser power output value at the moving speed v [m/s], and
β₁: a coefficient of correction.

9. The laser recording device according to claim 7, wherein, in a case of a second control scheme that maintains laser power output L[w] and a pulse width t [s] constant and allows a duty ratio (t/T) of a pulse width t [s] to a laser power output period T [s] to vary, the laser power output corrector is configured to correct the power output of the laser light using the following formula:
P=P₀+β₂((v₀−v)/v₀),
where
v₀ [m/s]: a reference moving speed,
v [m/s]: a moving speed,
P₀ [μs]: a pulse width at the reference moving speed v₀ [m/s],
P [μs]: a pulse width at the moving speed v [m/s], and
β₂: a coefficient of correction.

10. The laser recording device according to claim 7, wherein, in a case of a first control scheme that maintains a duty ratio (t/T) of a pulse width t [s] to a laser power output period T [s] constant, the laser power output corrector is configured to correct the power output of the laser light using the following formula:
L=L₀×(v/v₀)^{α1},
where
v₀ [m/s]: a reference moving speed,
v [m/s]: a moving speed,
L₀ [W]: a laser power output value at the reference moving speed v₀ [m/s],
L [W]: a laser power output value at the moving speed v [m/s], and
α₁: a coefficient of correction.

11. The laser recording device according to claim 7, wherein, in a case of a second control scheme that maintains laser power output L[w] and a pulse width t [s] constant and allows a duty ratio (t/T) of a pulse width t [s] to a laser power output period T [s] to vary, the laser power output corrector is configured to correct the power output of the laser light using the following formula:
P=P₀×(v₀/v)^{α2},
where
v₀ [m/s]: a reference moving speed,
v [m/s]: a moving speed,
P₀ [μs]: a pulse width at the reference moving speed v₀ [m/s],
P [μs]: a pulse width at the moving speed v [m/s], and
α₂: a coefficient of correction.

12. The laser recording device according to claim 8, wherein the laser power output corrector is configured to set a reference moving speed in a middle between a lowest speed and a highest speed.
